(19) United States
(12) Patent Application Publication
(10) Pub. No.: US 2019/0281770 A1
(43) Pub. Date: Sep. 19, 2019

(54) ECOLOGICAL ENVIRONMENTALLY-FRIENDLY FLOWERPOT FOR DISPOSING GARBAGE

(71) Applicant: Experimental Center of Desert Forestry, CAF, Dengkou County (CN)

(72) Inventors: Yingming Zhao, Bayannur City (CN); Yiben Cheng, Beijing (CN); Xue Dong, Bayannur City (CN); Yaru Huang, Hohhot City (CN); Yanli Li, Beijing (CN); Yuting Liu, Wuhai City (CN); Yingbin Ma, Bayannur City (CN); Wenbin Yang, Beijing (CN)

(21) Appl. No.: 15/949,242

(22) Filed: Apr. 10, 2018

(30) Foreign Application Priority Data
Mar. 16, 2018 (CN) 201810217328.7

(51) Int. Cl. A01G 9/02; B65F 1/14; B65F 1/16; A01G 24/20; A01G 27/00

(52) U.S. Cl. CPC A01G 9/028; B65F 1/1426; B65F 1/16; A01G 24/20; B65F 2250/128; B65F 2001/1489; B65F 2210/135; B65F 2230/135; A01G 27/00

(57) ABSTRACT

The present invention discloses an ecological environmentally-friendly flowerpot for disposing garbage, including an outer liner and an inner liner, wherein the inner liner is sleeved inside the outer liner, the inner liner is fixed to the inner wall of the outer liner by a plurality of connecting poles, and a sandwich layer for growing plants is formed between the inner liner and the outer liner; and the side wall of the inner liner is provided with a plurality of meshes, and the inner liner is in communication with the bottom of the outer liner. The flowerpot of the present invention can save water resources, is beneficial to garbage decomposition, and also facilitates plants in absorbing nutrients, thereby being more ecological environmentally-friendly.

This application claims the benefit of Chinese application Serial No. 201810217328.7, filed Mar. 16, 2018, the invention of which is incorporated by reference herein in its entirety.

### TECHNICAL FIELD

The present invention relates to the technical field of flowerpots, and more particularly, relates to an ecological environmentally-friendly flowerpot for disposing garbage.

### BACKGROUND

With the increasing of urban population density, more and more urban domestic garbage are generated, including kitchen garbage, toilet human excrement and toilet paper garbage, and these unrecyclable garbage bring heavy work to hygiene departments in garbage transportation and classification and easily cause environment pollution.

To solve the above-mentioned problems, many dustbin-type flowerpots, which can be used for disposing the generated domestic garbage, appear on the market. The existing dustbin-type flowerpots are designed with two boxes generally, for example, a patent with the patent No. of CN201110325401.0 and the title of “dustbin-type flowerpot” discloses that the flowerpot is divided into a planting region and a fermentation region, a baffle plate is arranged between the two regions, because root systems cannot grow to the fermentation region, the nutrient space for growth of root systems is reduced, although water and nutrients may pass through the water inlet to be absorbed by plants, most nutrients of the garbage in the decomposition process are still in the fermentation region, so that sufficient nutrients cannot be provided for plant growth.

For example, a patent with the patent No. of CN201620424645.2 and the title of “dustbin-type flowerpot using waste water discloses that only waste water is used and waste water is sprayed into the flowerpot by a circulating water pump, the use is monotonous, and the water pump may consume electric energy while in use, thereby not being environmentally-friendly and energy saving.

When domestic garbage is disposed, the generated detritus garbage and toilet garbage are flushed into sewerage by water. Because there are numerous people on the earth, flushing garbage by water may result in waste of a great deal of water resources.

Thus, the problem to be solved by those skilled in the art is to research an ecological environmentally-friendly flowerpot which can save water resources and benefit garbage decomposition.

### SUMMARY

For this purpose, the present invention provides an ecological environmentally-friendly flowerpot for disposing garbage, which can be used for decomposing garbage and can be used for growing plants as well.

To achieve the above purpose, the present invention adopts the following technical solution:

An ecological environmentally-friendly flowerpot for disposing garbage, including an outer liner and an inner liner, wherein the inner liner is sleeved inside the outer liner, the inner liner is fixed to the inner wall of the outer liner by a plurality of connecting poles, and a sandwich layer for growing plants is formed between the inner liner and the outer liner; and the side wall of the inner liner is provided with a plurality of meshes, and the inner liner is in communication with the bottom end of the outer liner.

For the above-mentioned content, in the present invention, garbage is placed inside the inner liner, plants are planted in the sandwich layer, because the inner liner has no inner liner bottom, the inner liner is in communication with the outer liner, nutriments decomposed from the garbage can be directly absorbed by the plants, and root systems of the plants can also extend to the inside of the inner liner through the meshes to directly absorb water and nutrients in the garbage mixture. Soil is placed in the sandwich layer, and soil is also placed on a portion from the outer liner bottom to the inner liner bottom; in this way, the soil in the sandwich layer can be prevented from slipping to the bottom of the outer liner. Moreover, soil is placed between the inner liner bottom and the outer liner bottom, and then garbage is placed in the inner liner, so that microorganisms in the soil may accelerate the decomposition speed of the garbage.

Preferably, the flowerpot further comprises an inner liner cover, wherein the inner liner cover is buckled with the inner liner. The inner liner cover can prevent the odor generated by garbage decomposition and fermentation from being emitted and affecting air quality.

Preferably, the connecting poles are set into two layers or more layers. The connecting poles are uniformly distributed in a staggered mode, and a stable triangle or square is formed by every two layers of connecting poles. Thus, the connection between the inner liner and the outer liner is made more secure.

Preferably, the bottom of the outer liner is connected with an outer liner bottom, and the outer liner bottom is provided with a hole. The hole has the functions of discharging water and ventilating air, guaranteeing that the root systems of plants and soil can normally breathe, preventing root systems from being heavily eroded, and preventing the microorganisms in the soil from dying.

Preferably, the inner liner, the outer liner and the connecting poles are made of the same material selected from any one of porcelain, mud and wood.

The present invention has the following beneficial effects:

1) in the present invention, the inner liner for receiving garbage is in communication with the sandwich layer for plant growth, and the side wall of the inner liner is provided meshes, so that root systems of the plants can extend into the inner liner to sufficiently absorb water and nutrients, thereby promoting plant growth;

2) both the sandwich layer and the inner liner are filled with soil, so that microorganisms in the soil can also play a role of promoting garbage decomposition while providing nutriments for plant growth;

3) no other energy-consuming device is not used in the process of garbage decomposition and the process for plants to absorb nutriments, thereby being energy-saving and environmentally-friendly;

4) since the flowerpot can decompose kitchen garbage and toilet garbage, the garbage generated in the toilet is received in a degradable plastic bag or paper bag and is placed in the inner liner of the flowerpot together with the degradable plastic bag or paper bag, so that the process of flushing garbage by water may be omitted, thereby saving water resources.

It is noted that the fund of the present invention is supported by Special Fund for Basic Scientific Research of Central Public-interest Scientific Institution of Chinese Academy of Forestry “Research on the Carbon Storage and Service Value of Farm-Shelter Forest in Desert-Oasis” (No.: CAFYBB2017MB002).

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is an inner structural diagram of a flowerpot provided by the present invention;

FIG. 2 is structural diagram of an inner liner cover provided by the present invention; and

FIG. 3 is a structural diagram of an outer liner bottom provided by the present invention.

In the drawings, legends: 1. inner liner cover; 2. handle; 3. outer liner; 4. inner liner; 5. connecting pole; 6. sandwich layer; 7. mesh; 8. outer liner bottom; 9. hole.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

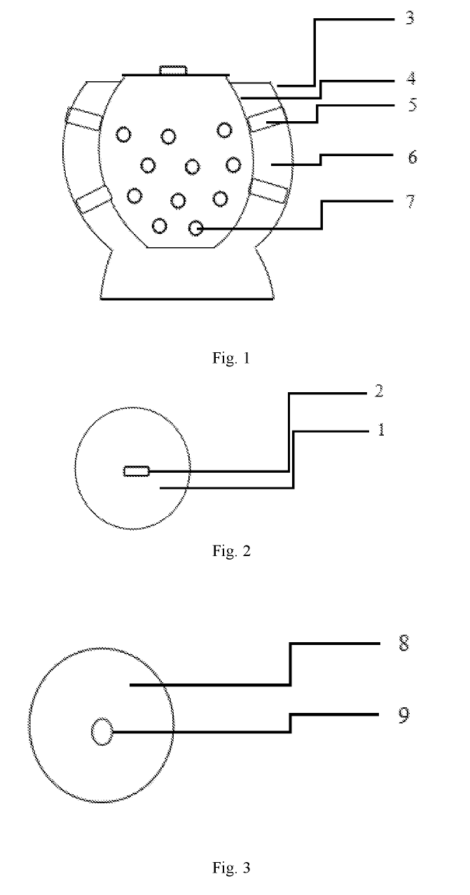

As shown in FIG. 1, an embodiment of the present invention discloses an ecological environmentally-friendly flowerpot for disposing garbage, including an outer liner 3 and an inner liner 4, wherein the inner liner 4 is sleeved inside the outer liner 3, the inner liner 4 is fixed to the inner wall of the outer liner 3 by a plurality of connecting poles 5, and a sandwich layer 6 for growing plants is formed between the inner liner 4 and the outer liner 3; and the side wall of the inner liner 4 is provided with a plurality of meshes 7, and the inner liner 4 is in communication with the bottom end of the outer liner 3. The inner liner 4 is in mutual communication with the outer liner 3, thereby facilitating root systems of plants in absorbing water and nutrients, and soil is mixed with garbage, thereby being more beneficial to garbage decomposition. The sizes of the meshes 7 in the side wall of the inner liner 4 should not be too large, so that soil in the sandwich layer 6 can be prevented from collapsing in the hole to avoid reducing the space for the inner liner 4 to receive garbage.

Further, the flowerpot further comprises an inner liner cover 1, wherein the inner liner cover 1 is buckled with the inner liner 4. The inner liner cover 1 is closely buckled with the top of the inner liner 4, so that the inside odor can be prevented from being emitted.

Further, the top of the inner liner cover 1 is also connected with a handle 2. The handle 2 is arranged to conveniently open and close the inner liner cover 1 and conveniently take out garbage from the inner liner 4.

Further, the connecting poles 5 are set into two layers or more layers. The connecting poles 5 are annularly and uniformly distributed in a staggered mode, and a stable triangle or square is formed by every two layers of connecting poles 5. Thus, the connection between the inner liner 4 and the outer liner 3 is made more secure, so that the phenomenon that the inner liner 4 mismatches the outer liner 3 because of multiple movements in use can be avoided.

Further, the bottom of the outer liner 3 is connected with an outer liner bottom 8, and the outer liner bottom 8 is provided with a hole 9, thereby facilitating plant growth.

Further, the inner liner 4, the outer liner 3 and the connecting poles 5 are made of the same material selected from any one of porcelain, mud and wood. The selected material may not make impact on environment. The connecting poles 5, the inner liner 4 and the outer liner 3 are made of the same material, so that the phenomenon that the connection between the inner liner 4 and the outer liner 3 is insecure due to gaps generated because of different thermal expansion coefficients can be avoided.

Further, the volume ratio of the inner liner 4 to the outer liner 3 is 1:5-1:2. Within this ratio range, it can be guaranteed that the speed for the inner liner 4 to degrade garbage is appropriate, and it can be guaranteed that the space for plants in the sandwich layer 6 to grow is appropriate as well, so that the plant growth speed and decomposition speed meet garbage decomposition speed. In accordance with different usage occasions, flowerpots of different sizes and shapes may be produced according to the ratio of the inner liner 4 to the outer liner 3.

Further, the connecting poles 5 are inserted in the inner liner 4 and the outer liner 3, and the connecting poles 5 are in close contact with the inner liner 4 and the outer liner 3, wherein the mass of the inner liner 4 borne by the contact area per square meter is less than 806 Kg. Because the inner liner 4 has certain weight itself and the inner liner 4 has no inner liner bottom, there is a need for the connecting poles 5 to bear the weight of the inner liner 4 when connecting the inner liner 4 with the outer liner 3, to guarantee the mass of the inner liner borne by the contact area per square meter is less than 806 Kg, so that it can be guaranteed that the connecting poles 5 can bear the weight of the inner liner 4 while in use without breaking phenomenon.

Further, excrement generated in toilet and toilet paper garbage can be directly poured in the flowerpot, so that the process of flushing the garbage by water may be omitted, and a large number of water resources may be saved. When the toilet garbage is disposed, the number of flowerpots may be appropriately increased according to the number of family members, to meet the requirement that the decomposition speed of garbage is adapted the generation speed of garbage.

Usage Method of the Present Invention:

Soil is filled in the sandwich layer 6 of the flowerpot, the soil may slip to the bottom of the outer liner 3, when the soil at the bottom of the outer liner 3 is added to the bottom end of the inner liner 4, the soil inside the inner liner 4 may not be increased any longer, soil is continuously added to the sandwich layer 6 until the sandwich layer 6 is fully filled, a space of 5-10 cm is required to be reserved between the soil surface of the sandwich layer 6 and the top of the outer liner 3, to facilitate planting and watering.

Green ornamental plants or fruits and vegetables are planted in the sandwich layer 6 and are kept at appropriate plant spacing, to avoid fierce competition for nutrients. Some earthworms are added into the soil of the sandwich layer 6 to enhance the soil porosity, fertility and capacity of decomposing garbage. When garbage is added into the inner liner 4, some soil are dug out first for coverage, and a little of soil is additionally added, to avoid reducing the garbage disposal space.

The mixture of garbage and soil fermented for a long time, as fertilizer, may be added into ordinary flowerpots or packaged for storage or sale, to restore the garbage disposal space of dustbin-type flowerpots and improve the garbage disposal capacity of dustbin-type flowerpots.

When kitchen garbage is disposed, the degradable garbage is fragmented and then is added into the inner liner 4, a little of soil and then an appropriate amount of water are added therein, the mixture is stirred until well mixed to accelerate garbage decomposition, it is covered a little of soil, and then the inner liner cover 1 is closed.

When toilet garbage is disposed, a degradable plastic bag or paper bag is sleeved on the commode to collect excrement, the degradable plastic bag is placed in the inner liner 4, it is covered with soil, and then the inner liner cover 1 is placed. When toilet garbage is disposed, the process of commode flushing may be omitted, water resources may be saved, and fertilizer may be provided for plant growth as well. The number of dustbin-type flowerpots of each family shall match that of family members, and shall be 2-3 times more than that of the family members, to make the garbage production be adapted to the soil microorganism and animal decomposition speed as far as possible. For the addition of the toilet garbage, garbage of male shall be mixed with garbage of female, to prevent the value of a certain hormone in soil from being too high to affect plant growth.

This flowerpot can also be placed on the road, in the park or the like, the planted flowers and plants can beautify the environment, and the flowerpot can also serve as a dustbin, and can deteriorate degradable garbage for use.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. An ecological environmentally-friendly flowerpot for disposing garbage, characterized by comprising an outer liner (3) and an inner liner (4),
wherein the inner liner (4) is sleeved inside the outer liner (3), the inner liner (4) is fixed to the inner wall of the outer liner (3) by a plurality of connecting poles (5), and a sandwich layer (6) for growing plants is formed between the inner liner (4) and the outer liner (3); and
the side wall of the inner liner (4) is provided with a plurality of meshes (7), and the inner liner (4) is in communication with the bottom end of the outer liner (3).

2. The ecological environmentally-friendly flowerpot for disposing garbage according to claim 1, characterized by further comprising an inner liner cover (1), wherein the inner liner cover (1) is buckled with the inner liner (4).

3. The ecological environmentally-friendly flowerpot for disposing garbage according to claim 2, characterized in that the top of the inner liner cover (1) is also connected with a handle (2).

4. The ecological environmentally-friendly flowerpot for disposing garbage according to claim 1, characterized in that the plurality of connecting poles (5) are set into two layers or more layers.

5. The ecological environmentally-friendly flowerpot for disposing garbage according to claim 1, characterized in that the bottom of the outer liner (3) is connected with an outer liner bottom (8), and the outer liner bottom (8) is provided with a hole (9).

6. The ecological environmentally-friendly flowerpot for disposing garbage according to claim 1, characterized in that the inner liner (4), the outer liner (3) and the connecting poles (5) are made of the same material selected from any one of porcelain, mud and wood.

7. The ecological environmentally-friendly flowerpot for disposing garbage according to claim 1, characterized in that the volume ratio of the inner liner (4) to the outer liner is 1:5-1:2.

8. The ecological environmentally-friendly flowerpot for disposing garbage according to claim 1, characterized in that the connecting poles (5) are inserted in the inner liner (4) and the outer liner (3), and the connecting poles (5) are in close contact with the inner liner (4) and the outer liner (3), wherein the mass of the inner liner (4) borne by the contact area per square meter is less than 806 Kg.

9. The ecological environmentally-friendly flowerpot for disposing garbage according to claim 4, characterized in that the inner liner (4), the outer liner (3) and the connecting poles (5) are made of the same material selected from any one of porcelain, mud and wood.

10. The ecological environmentally-friendly flowerpot for disposing garbage according to claim 4, characterized in that the connecting poles (5) are inserted in the inner liner (4) and the outer liner (3), and the connecting poles (5) are in close contact with the inner liner (4) and the outer liner (3), wherein the mass of the inner liner (4) borne by the contact area per square meter is less than 806 Kg.
